(19) United States
(12) Patent Application Publication
(10) Pub. No.: US 2012/0036866 A1
(43) Pub. Date: Feb. 16, 2012

(54) AUXILIARY POWER UNIT WITH MULTIPLE FUEL SOURCES

(75) Inventor: Adam M. Finney, Rockford, IL (US)

(73) Assignee: HAMILTON SUNDSTRAND CORPORATION, Windsor Locks, CT (US)

(21) Appl. No.: 12/854,230

(22) Filed: Aug. 11, 2010

(51) Int. Cl. F02C 6/00; F17D 1/00; G05D 11/00

(52) U.S. Cl. 60/801; 137/98; 137/2

(57) ABSTRACT

A system and method are disclosed for supplying fuel to an auxiliary power unit of an aircraft. The system includes a primary fuel source, a secondary fuel source, and a secondary valve. The primary fuel source is in fluid communication with the auxiliary power unit to provide a primary fuel thereto. Similarly, the secondary fuel source is in fluid communication with the auxiliary power unit to provide a secondary fuel thereto. The secondary valve regulates flow of the secondary fuel from the secondary fuel source to the auxiliary power unit. The method provides a secondary fuel from a secondary fuel source to the auxiliary power unit if an emergency operating condition experienced by the aircraft results from either exhaustion or contamination of a primary fuel.

### BACKGROUND

The present invention relates to an auxiliary power unit, and more particularly, to a fuel supply system for an auxiliary power unit that has two or more fuel sources.

Auxiliary power units (APUs) are a necessary part of most commercial and military aircraft. APUs are designed to meet aviation power needs during ground operations, when the main engines are not running. APUs provide power for electrical and instrumentation systems, hydraulic systems, and main engine startup, and supply cabin air to the environmental control system. More recently, aircraft have begun to use APUs not just for necessary ground operations but for in-flight functions. Thus, APUs are increasingly configured to operate as standalone sources of accessory power and cabin air, independent of the main engines.

A majority of aircraft emergencies that involve the failure of primary power source(s) (e.g., main engine driven hydraulic pumps and/or main engine driven electrical generators) are the result of the failure of the main engine due to jet fuel exhaustion or jet fuel contamination. Regulations require that aircraft have an emergency power source that is independent of the primary power source(s). The emergency power source is necessary to control an aircraft's flight surfaces in the event of a loss of the primary power sources.

Normally a ram air turbine, called a RAT, is used to provide emergency electrical power in the event of gas turbine engine failure. The RAT is an electrical generator or hydraulic pump equipped with a propeller that is commonly mounted within the body of the aircraft. In emergency conditions, the RAT is deployed into the air stream surrounding the aircraft to rotate and generate electrical or hydraulic power for the aircraft's systems.

One consideration associated with the RAT is the additional weight the unit adds to the aircraft. This additional weight may impose a fuel and performance penalty. Considering this, eliminating or reducing the size of the RAT could be advantageous.

### SUMMARY

A system and method are disclosed for supplying fuel to an auxiliary power unit of an aircraft. The system includes a primary fuel source, a secondary fuel source, and a secondary valve. The primary fuel source is in fluid communication with the auxiliary power unit to provide a primary fuel thereto. Similarly, the secondary fuel source is in fluid communication with the auxiliary power unit to provide a secondary fuel thereto. The secondary valve regulates flow of the secondary fuel from the secondary fuel source to the auxiliary power unit.

The method provides a secondary fuel from a secondary fuel source to the auxiliary power unit if an emergency operating condition experienced by the aircraft results from either exhaustion or contamination of a primary fuel.

### BRIEF DESCRIPTION OF THE DRAWINGS

FIG. 1 is a schematic of one embodiment of a fuel system for supplying an auxiliary power unit.

FIG. 2 is a schematic of another embodiment of the fuel system for supplying the auxiliary power unit.

FIG. 3 is a schematic of yet another embodiment of the fuel system for supplying the auxiliary power unit.

FIG. 4A is a flow chart illustrating a method of supplying fuel to the auxiliary power unit.

FIG. 4B is a flow chart illustrating another method of supplying fuel to the auxiliary power unit.

### DETAILED DESCRIPTION

The present disclosure describes a fuel supply system for an auxiliary power unit with both primary and auxiliary (secondary or backup) fuel sources. These dual fuel sources greatly increase the probability that fuel will be provided to the auxiliary power unit in the event of an emergency that results from fuel exhaustion or fuel contamination on an aircraft. In the case where the emergency results from fuel exhaustion or fuel contamination, the auxiliary power unit, supplied by auxiliary fuel, can power various crucial pumps and emergency generators that would allow the aircraft to descend and land safely. The fuel supply system with dual fuel sources is additionally beneficial because the weight of the aircraft employing such a system would be reduced by eliminating or reducing the size of the ram air turbine using the auxiliary power unit that already exists for ground operations.

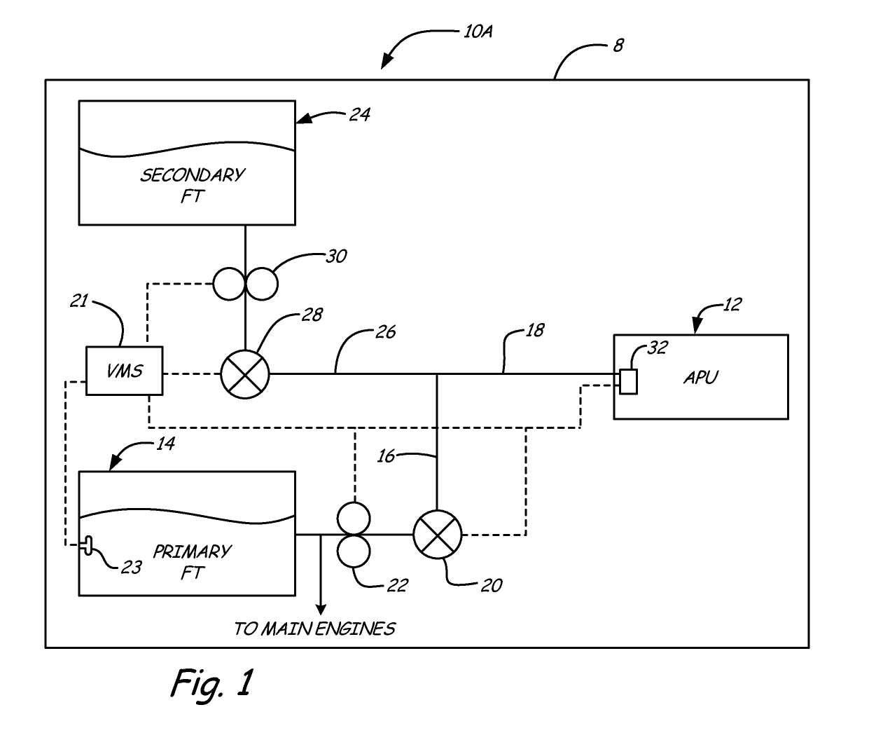

FIG. 1 shows an embodiment of the fuel supply system 10A for the auxiliary power unit 12 (hereinafter, “APU”) of an aircraft 8. The embodiment of the fuel supply system 10A shown in FIG. 1 includes a primary fuel source 14, a primary APU fuel line 16, a combined APU fuel line 18, a primary valve 20, a primary pump 22, an (auxiliary) secondary fuel source 24, a secondary APU fuel line 26, a secondary valve 28, and a secondary pump 30. The APU 12 includes fuel injectors 32. The fuel supply system 10A and APU 12 provide an emergency power system for the aircraft 8.

The fuel supply system 10A is in fluid communication with the APU 12 to provide fuel thereto. The general construction and operation of APUs for aircraft is well-known in the art, and therefore, a detailed discussion herein is unnecessary. As will be described subsequently, the fuel supply system 10A provides fuel to the APU 12, which operates to drive various actuators such as hydraulic pumps and/or electrical generators during emergency operation of the aircraft 8. The APU 12 can also provide power to start the main turbine engines during startup operation of the aircraft 8 in a manner known in the art.

The fuel supply system 10A has two or possibly more fuel sources. For convenience only a single emergency (auxiliary) fuel source 24 is illustrated in addition to the primary fuel source 14. The primary fuel source 14 comprises the primary fuel tanks of the aircraft 8. As shown in FIG. 1, the primary fuel source 14 communicates a primary fuel to the APU 12 via the primary APU fuel line 16 and the combined APU fuel line 18, which connect together upstream of the APU 12. Most commonly the primary fuel utilized for operation of the aircraft 8 comprises a jet fuel such as Jet A or Jet A-1.

The primary valve 20 is disposed in communication with the primary APU fuel line 16 and the pump 22 regulates the flow of the primary fuel from the primary fuel source 14 to the APU 12. In one embodiment, the primary valve 20 is responsive to control signals from a Vehicle Management System (VMS) 21 to regulate the flow of the primary fuel. In other embodiments, the primary valve 20 can actuate as result of a loss of primary power thereto (as a result of e.g., a loss of power generation by the primary generator) to regulate primary fuel flow. For example, the primary valve 20 can comprise a ball valve that is actuated hydraulically or with a solenoid. When actuated in response to a loss of primary power thereto (or via control signals from the VMS 21), the ball valve has a component that moves from a first position, which allows the primary fuel to pass therethrough, to a second position which halts fuel flow from the primary fuel source 14 to the APU 12. In other embodiments, the primary valve 20 can comprise any valve (including variable valves) known in the art for regulating fuel flow within an aircraft.

The VMS 21 electronically communicates with the APU 12, the primary valve 20, the primary pump 22, the secondary valve 28, the secondary pump 30, and a sensor 23 that is disposed in the primary fuel source 14 or primary APU fuel line 16. The sensor 23 measures if primary fuel is in the fuel system 10A. The primary pump 22 is disposed in communication with the primary APU fuel line 14 and is responsive to control signals from the VMS 21 to deliver the primary fuel from the primary fuel source 14 to the APU 12. Similar to the primary valve 20, the primary pump 22 can comprise any pump known in the art for distributing fuel within an aircraft. In one embodiment, the primary pump 22 can comprise an electric positive displacement fuel pump. In another embodiment, the primary pump 22 can comprise a motive flow fuel pump.

The secondary fuel source 24 comprises one or more fuel tanks that are disposed within the aircraft 8. The fuel tank(s) contain a dedicated supply of secondary fuel for the APU 12 and only supply it to the APU 12 during certain emergency operation conditions aboard the aircraft 8. As shown in FIG. 1, the secondary fuel source 24 communicates a secondary fuel to the APU 12 via the secondary APU fuel line 26 and the combined APU fuel line 18, which connect together upstream of the APU 12. In one embodiment, the secondary fuel differs in composition from the primary fuel. In particular, the secondary fuel can comprise a synthetic hydrocarbon blend such as Jet Propellant 10 (JP-10) or a Fischer-Tropsch fuel with a longer storage life than the primary fuel.

The secondary valve 28 is disposed in communication with secondary APU fuel line 26 and regulates the flow of the secondary fuel from the secondary fuel source 24 to the APU 12. Similar to the primary valve 20, the secondary valve 28 can comprise a ball valve. The secondary valve 28 can be responsive to control signals from the VMS 21 to regulate the flow of the secondary fuel. In other embodiments, secondary valve 28 can be configured to actuate in response to certain emergency operating conditions such as a loss of power to the secondary valve 28 (resulting from e.g., a loss of power generation by the primary generator for the aircraft 8) to allow the secondary fuel to pass therethrough and flow from the secondary fuel source 24 to the APU 12. The secondary valve 28 and the primary valve 20 can be configured to close and open in tandem. This can be in response to control signals indicating certain emergency operating conditions for the aircraft 8 including primary fuel exhaustion or primary fuel contamination. In such situations, the secondary valve 28 is responsive to control signals from the VMS 21 to open and provide flow from the secondary fuel source 24 to the APU 12 and the primary valve 20 is responsive to control signals from the VMS 21 to close and halt primary fuel flow from the primary fuel source 14 to the APU 12.

The tandem opening and closing of the secondary valve 28 and the primary valve 20 can also be the result of a loss of power to both of the valves 20 and 28 from primary power sources. In this case, the loss of power to the primary valve 20 would cause the primary valve 20 to close and halt the flow of the primary fuel, while the loss of primary power to the secondary valve 28 would cause the secondary valve 28 to open and allow the secondary fuel to flow to the APU 12.

The secondary pump 30 is disposed in communication with the secondary APU fuel line 26 and is responsive to control signals from the VMS 21 to deliver the primary fuel from the secondary fuel source 24 to the APU 12. The secondary pump 30 can comprise any pump known in the art for distributing fuel within an aircraft including an electric fuel pump.

The combined APU fuel line 18 directs either the primary fuel or the secondary fuel (depending on the operating state of the aircraft 8) to the fuel injectors 32 within the combustor section of the APU 12. After passing through the fuel injectors 32 the primary fuel or the secondary fuel is ignited to drive the APU 12. During initial emergency operation of the aircraft 8 prior to and during initial startup of APU 12, actuation/operation of the primary valve 20, the primary pump 22, the secondary valve 28, and the secondary pump 30 can be powered by alternative power source(s) known in the art including the aircraft's emergency batteries, a small ram air turbine, and/or emergency generators driven by the primary turbine engines in a windmill condition. As discussed previously, in some embodiments the primary valve 20 and the secondary valve 28 can be configured to actuate to regulate the primary and secondary fuel by the loss of power generation by the main generators of the aircraft 8.

Startup of APU 12 at high altitude can be accomplished in a manner known in the art. In particular, APU 12 or fuel supply system 10A can be outfitted with an incendiary device as disclosed in U.S. Pat. No. 4,965,995 to Vershure, Jr. et al. which is incorporated herein by reference. Startup of APU 12 could also be accomplished by a jet fuel starter or by utilizing chemical means such as those disclosed in U.S. Pat. Nos. 3,722,217, 3,800,534 and 4,033,115, which are incorporated herein by reference.

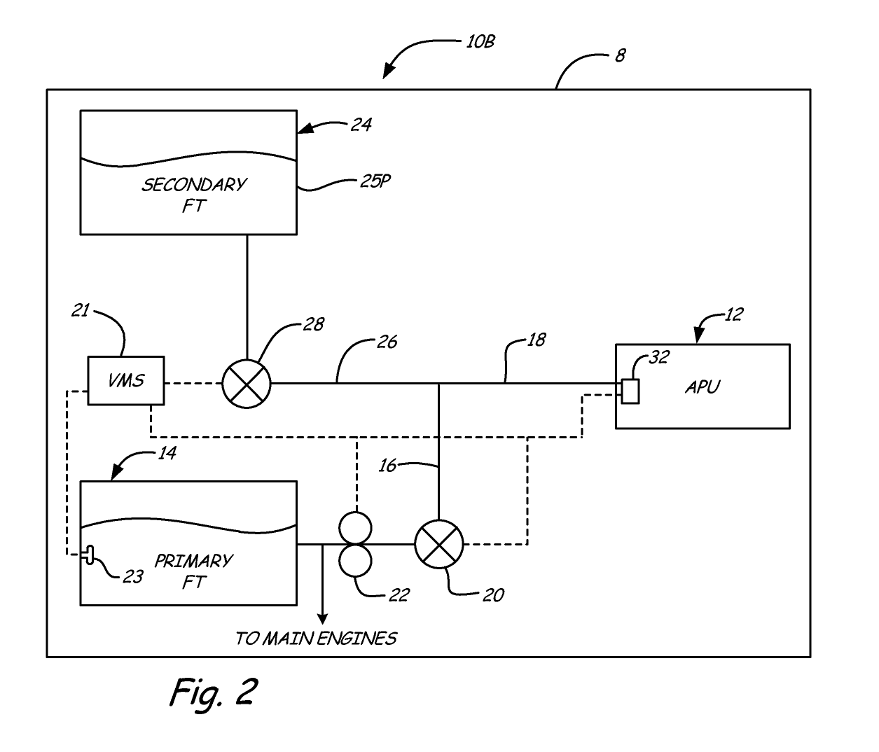

FIG. 2 shows another embodiment of the fuel supply system 10B for the APU 12 of the aircraft 8. The fuel supply system 10B operates in a manner similar to and has many components identical to that of the fuel system 10A shown in FIG. 1. However, the secondary fuel source 24 of the fuel supply system 10B comprises a pressurized fuel tank 25P.

In the event certain emergency operating conditions for the aircraft 8 including primary fuel exhaustion or primary fuel contamination, a pressure differential in the system 10B that results from the pressurized fuel tank 25P delivers the secondary fuel along the secondary APU fuel line 26 and the combined APU fuel line 18 from the pressurized fuel tank 25P to the APU 12. In particular, the secondary fuel within the fuel tank 25P can be pressurized in a manner know in the art including via pneumatic pressure that pushes upon a bladder carrying the secondary fuel within the fuel tank 25P or by a spring loaded piston. The pressure exerted upon the secondary fuel within the tank 25P will depend on the design of the APU 12. The pressure should be selected to optimize the fuel flow rate into the combustion chamber of the APU 12. In one embodiment, the pressure should be between about 50 and 100 psi (0.345 and 0.70 MPa) above the pressure within the combustion chamber of the APU 12.

Employing the pressurized fuel tank 25P eliminates the need for a pump to deliver secondary fuel from the secondary fuel source 24 to the APU 12 in the fuel supply system 10B. As discussed previously, the secondary valve 28 can be actuated by control signals from the VMS 21, or by a combination of a loss of primary power to the secondary valve 28 coupled with the pressure in the secondary fuel source 24.

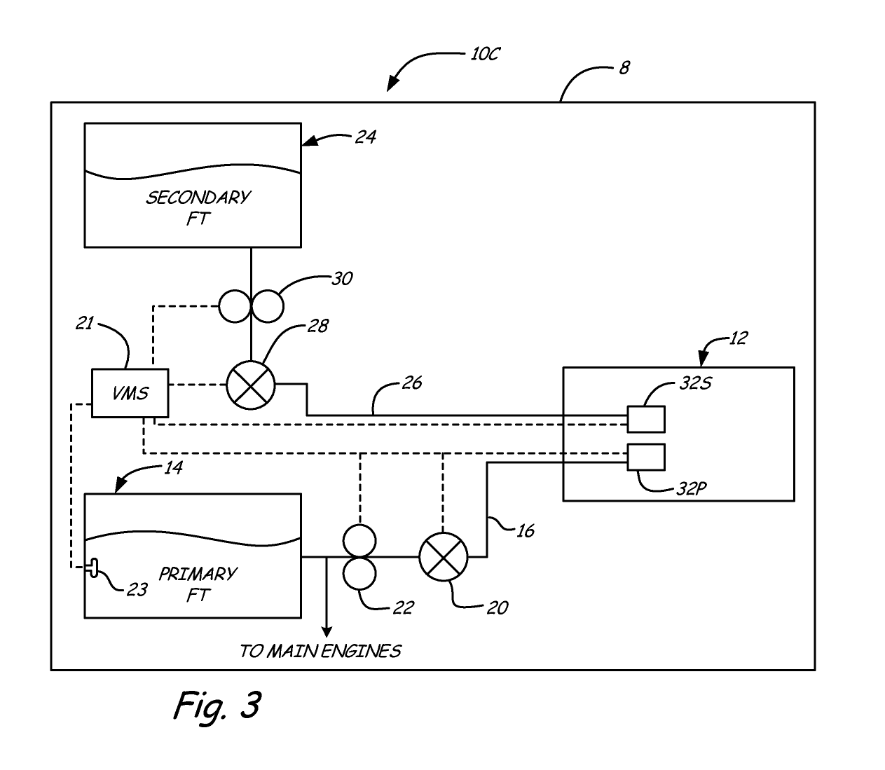

FIG. 3 shows yet another embodiment of the fuel supply system 10C for the APU 12 of the aircraft 8. The fuel supply system 10C operates in a manner identical to and has many components similar to that of the fuel system 10A shown in FIG. 1. However, the secondary APU fuel line 26 and the primary APU fuel line 16 of the fuel supply system 10C are entirely separated from each other. This eliminates the combined APU fuel line 18 shown in FIG. 1.

The secondary APU fuel line 26 communicates secondary fuel from the secondary fuel source 24 to secondary fuel injectors 32S within the APU 12. Similarly, primary APU fuel line 16 communicates primary fuel from the primary fuel source 14 to primary fuel injectors 32P within the APU 12. Thus, the primary fuel and the secondary fuel follow entirely separate flow paths to the primary fuel injectors 32P and the secondary fuel injectors 32S, respectively. The configuration of fuel supply system 10C eliminates the probability that contaminants from the primary fuel will clog all the fuel injectors of the APU 12 making it difficult or impossible to inject secondary fuel into the APU 12 during emergency operation of the aircraft 8.

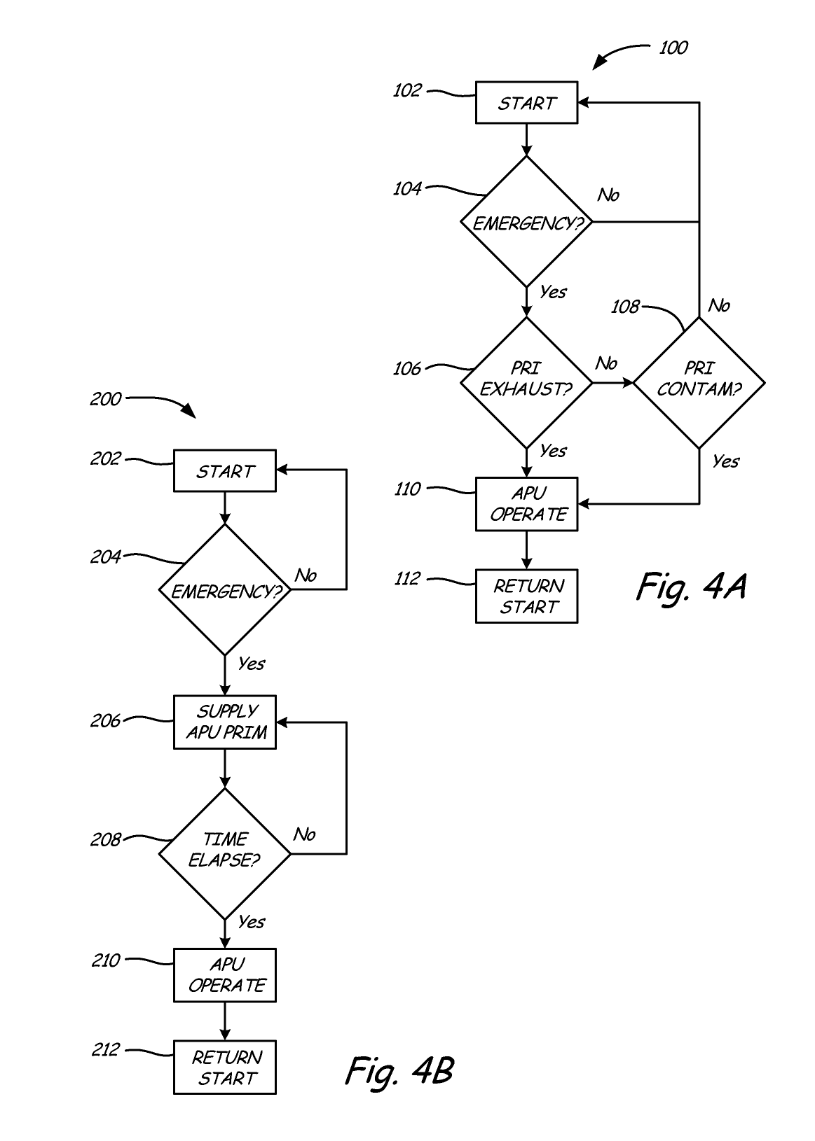

FIG. 4A is a flow chart illustrating a method 100 of supplying fuel to the APU 12. The method 100 can be part of the logic used by the VMS 21 of the aircraft 8 to determine if the APU 12 requires secondary fuel from the secondary fuel source 24 (FIGS. 1-3).

The method 100 starts at block 102 and proceeds to query block 104. In start block 102, the APU 12 runs with primary fuel. A query block 104 determines whether any emergency operating condition for the aircraft 8 exists. This condition can be ascertained by methods known in the art, some of which include the pilot manually indicating an emergency, the main turbine engine shaft speed fluctuating in a manner associated with a windmill condition, and/or the main engine generators not spinning, and therefore, not producing electrical power.

If no emergency condition exists, the method 100 returns to the start block 102. If an emergency condition exists, the method 100 proceeds from the query block 104 to a query block 106. The query block 106 ascertains whether the primary fuel in the primary fuel source 14 is exhausted. This can be accomplished using the sensors 23 disposed in or adjacent the primary fuel source 14. If the query block 106 determines that the primary fuel is still available, and therefore, primary fuel is not exhausted, then the method 100 moves to a query block 108. If the query block 106 ascertains that the primary fuel has been exhausted, method 100 proceeds to a block 110.

The query block 108 determines if the primary fuel is contaminated. This is determined by, for example, abnormally large or increasingly large fuel pressure drops through the various components of the fuel supply system. Additionally, contamination of the primary fuel could be ascertained by assuming that if the primary fuel is available in the system yet no fuel is reaching the APU 12 then there must be a blockage in the primary portion of the system (e.g., in the primary APU fuel line 16, the combined APU fuel line 18, the primary valve 20, the primary pump 22, or the fuel injectors 32). If the block 108 determines that the primary fuel is not contaminated, the method 100 returns to the start block 102 where the APU 12 runs with primary fuel.

If the query block 106 determines that the primary fuel is exhausted, or if the query block 108 determines that the primary fuel is contaminated, then the method 100 moves to a block 110. In the block 110, the fuel supply system operates in the manner previously described with reference to FIGS. 1-3 to provide the secondary fuel to the APU 12. After the aircraft 8 ceases emergency operation, the block 110 moves to a block 112, which returns the method 100 to the start block 102 where the APU 12 runs with primary fuel.

FIG. 4B is a flow chart illustrating a second method 200 of supplying fuel to the APU 12. In some respects, the method 200 operates in a manner similar to the method 100. The method 200 proceeds from a start block 202, where the APU 12 is supplied with primary fuel, to a query block 204. The query block 204 determines whether any emergency operating condition for the aircraft 8 exists. This can be ascertained in the manner previously described.

If no emergency condition is determined to exist, the method 200 returns to the start block 202 where the APU 12 is supplied with primary fuel. If an emergency condition exists, the method 200 proceeds from the query block 204 to a block 206. The block 206 continues to attempt to supply the APU 12 with the primary fuel from the primary fuel source 14 (FIGS. 1-3). The method 200 moves from the block 206 to a query block 208. The query block 208 determines if a predetermined period of time has elapsed without the APU 12 starting. In one embodiment, the predetermined time period can be between 2 and 5 seconds. If the predetermined time period has not elapsed, the method 200 returns to the block 206. If the predetermined time period has elapsed and the APU 12 has not started, the method 200 proceeds to a block 210. In the block 210, the fuel supply system operates in the manner previously described to supply the secondary fuel to the APU 12. After the aircraft 8 ceases emergency operation the block 210 moves to a block 212, which returns the method 200 to the start block 202 where APU 12 is supplied with primary fuel.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

1. A fuel supply system for an auxiliary power unit of an aircraft, the system comprising:
a primary fuel source in fluid communication with the auxiliary power unit of the aircraft to provide a primary fuel thereto;
a secondary fuel source in fluid communication with the auxiliary power unit of the aircraft to provide a secondary fuel thereto; and
a secondary valve regulating flow of the secondary fuel from the secondary fuel source to the auxiliary power unit of the aircraft.

2. The system of claim 1, further comprising a primary valve regulating fuel flow from the primary fuel source to the auxiliary power unit of the aircraft.

3. The system of claim 2, wherein the secondary valve is responsive to control signals to open and provide fuel flow from the secondary fuel source to the auxiliary power unit during emergency operation of the aircraft and the primary valve is responsive to control signals to close and halt fuel flow from the primary fuel source to the auxiliary power unit during the emergency operation of the aircraft.

4. The system of claim 3, further comprising a secondary fuel pump responsive to control signals to deliver the secondary fuel from the secondary fuel source to the auxiliary power unit during emergency operation of the aircraft.

5. The system of claim 3, wherein the secondary fuel source comprises a pressurized fuel tank, and wherein a pressure differential in the system delivers the secondary fuel from the pressurized fuel tank to the auxiliary power unit.

6. The system of claim 3, wherein the emergency operation results from fuel exhaustion or fuel contamination of the primary fuel provided by the primary fuel source.

7. The system of claim 1, wherein the secondary fuel differs in composition from the primary fuel.

8. The system of claim 7, wherein the secondary fuel comprises a synthetic hydrocarbon blend with a longer storage life than the primary fuel.

9. The system of claim 2, wherein the primary fuel source communicates with one or more primary fuel injectors within the auxiliary power unit and the secondary fuel source communicates with one or more secondary fuel injectors within the auxiliary power unit, and wherein the primary fuel and the secondary fuel follow entirely separate flow paths to the primary fuel injectors and the secondary fuel injectors, respectively.

10. A method of supplying fuel to an auxiliary power unit of an aircraft, the method comprising:
identifying an emergency operating condition for the aircraft;
determining if the emergency operating condition results from either exhaustion or contamination of a primary fuel for the aircraft; and
providing a secondary fuel from a secondary fuel source to the auxiliary power unit if the emergency operating condition results from either exhaustion or contamination of the primary fuel.

11. The method of claim 10, wherein providing the secondary fuel to the auxiliary power unit comprises:
controlling a secondary valve to open and provide the secondary fuel to the auxiliary power unit from the secondary fuel source; and
controlling a primary valve to close and halt flow of the primary fuel from a primary fuel source to the auxiliary power unit.

12. The method of claim 11, further comprising:
controlling a secondary fuel pump to deliver the secondary fuel from the secondary fuel source to the auxiliary power unit.

13. The method of claim 12, wherein providing the secondary fuel from the secondary fuel source to the auxiliary power unit includes directing the secondary fuel through a dedicated secondary fuel line from the secondary fuel source to one or more secondary fuel injectors within the auxiliary power unit.

14. The method of claim 10, wherein the secondary fuel differs in composition from the primary fuel.

15. The method of claim 10, wherein determining if the emergency operating condition results from either exhaustion or contamination of a primary fuel includes continuing to provide primary fuel to the auxiliary power unit for a predetermined period of time after occurrence of the emergency operating condition and sensing to determine if the auxiliary power unit has started during the predetermined period of time.

16. An emergency power system for an aircraft comprising:
an auxiliary power unit;
a primary fuel source in fluid communication with the auxiliary power unit to provide a primary fuel thereto;
a secondary fuel source in fluid communication with the auxiliary power unit to provide a secondary fuel thereto; and
a secondary valve regulating flow of the secondary fuel from the secondary fuel source to the auxiliary power unit.

17. The system of claim 16, further comprising a primary valve regulating fuel flow from the primary fuel source to the auxiliary power unit of the aircraft.

18. The system of claim 17, wherein the secondary valve is responsive to control signals to open and provide fuel flow from the secondary fuel source to the auxiliary power unit during emergency operation of the aircraft and the primary valve is responsive to control signals to close and halt fuel flow from the primary fuel source to the auxiliary power unit during the emergency operation of the aircraft.

19. The system of claim 18, wherein the emergency operation results from fuel exhaustion or fuel contamination of the primary fuel provided by the primary fuel source.

20. The system of claim 17, wherein the primary fuel source communicates with one or more primary fuel injectors within the auxiliary power unit and the secondary fuel source communicates with one or more secondary fuel injectors within the auxiliary power unit, and wherein the primary fuel and the secondary fuel follow entirely separate flow paths to the primary fuel injectors and the secondary fuel injectors, respectively.
